(19) United States
(12) Patent Application Publication
(10) Pub. No.: US 2011/0056593 A1
(43) Pub. Date: Mar. 10, 2011

(54) Flaky Powder for an Electromagnetic Wave Absorber, and Method for Producing Same

(75) Inventors: Jai-Sung Lee, Seoul (KR); Sang-Kyun Kwon, Incheon (KR); Ji-Man Ryu, Jeonllabukdo (KR)

(73) Assignee: IUCF-HYU (Industry-University Cooperation Foundation Hanyang University), Seoul (KR)

(21) Appl. No.: 12/991,751

(22) PCT Filed: Jul. 31, 2009
(86) PCT No.: PCT/KR2009/004294

§ 371 Date: Nov. 9, 2010

(30) Foreign Application Priority Data
Apr. 7, 2009 (KR) 10-2009-0029944
May 25, 2009 (KR) 10-2009-0045395

(51) Int. Cl. B22F 1/00; B82Y 30/00; B82Y 40/00

(52) U.S. Cl. 148/513; 148/400; 977/777; 977/900

(57) ABSTRACT

A flake powder for an electromagnetic wave absorber and a method of manufacturing the flake powder are described. The flake powder is made-up of nano-sized metals and pores forming a flake body having a composite structure formed by aggregation of nano-sized magnetic metals. The method includes the steps of preparing a metal oxide; milling the metal oxide into nano-sized powder; reducing the milled metal oxide powder to form a magnetic metal powder; flaking the reduced magnetic metal powder; and heat treating the flaked magnetic metal powder to relieve residual stress thereof.

### BACKGROUND OF THE INVENTION

1. Field of the Invention

The present invention relates to a raw material of an electromagnetic wave absorber for an electronic product that generates electromagnetic waves, and more particularly, to a flake powder for an electromagnetic wave absorber, which utilizes a nano-sized magnetic material, and a method of manufacturing the same.

2. Description of the Related Art

Recently, electromagnetic interference (EMI) has brought about problems in a variety of industrial fields such as the medical, electronic, military, and aerospace sectors. EMI appears in diverse forms including computer malfunctions, the sudden acceleration of cars, and even the complete destruction of a factory due to fire. Therefore, efforts have been made to tighten regulations on electromagnetic waves and provide solutions therefore mainly by developed countries.

As one method for solving EMI, as shown in FIG. 1A, an electromagnetic wave shielding material, typically formed of a ferrite magnetic powder or a conductive metal powder such as Ag, is applied to the outer and inner walls of a device to thereby reflect generated electromagnetic waves. However, this method fails to fundamentally eliminate electromagnetic waves, and cannot be a fundamental solution for EMI.

Therefore, an alternative method has recently been studied to develop a technique in which a thin composite sheet, made by dispersing a magnetic metal powder in a polymer, is installed in the vicinity of a noise source to thereby absorb incident electromagnetic noise energy in the form of its magnetic loss. As shown in FIG. 1B, an electromagnetic wave absorber converts electromagnetic waves into thermal energy, and is often used for portable electronic products. In order to enhance the efficiency of the electromagnetic wave absorber, the performance of a magnetic powder, a base material, needs to be improved, and thus the study thereof is being conducted.

A magnetic material to which a metal plate, formed of a metal powder and ferrite having a soft magnetic property, is attached has a high level of absorbency in a relatively wide frequency range. The characteristics of such electromagnetic wave absorber are determined according to the dielectric constant and magnetic permeability of a material, and the thickness of the absorber. Representative materials in current use include Fe—Si—Al (sendust), Fe—Si, Ni—Fe (permalloy) mainly composed of Ni, and a ribbon type powder material, obtained by thermally treating Mo—Ni—Fe (MPP) and an Fe-based amorphous alloy and crystallizing the resultant material on nanoscale.

The magnetic material needs to have a high level of absorbency with respect to a relatively wide frequency range. In addition, the current trend toward smaller electronic products increases the demand for a thinner electromagnetic wave absorber having a higher absorbency. To this end, there is a need to develop an electromagnetic wave absorber for fundamentally eliminating electromagnetic waves generated within a wide-band frequency range, and problems need to be solved in two aspects, appropriate material design and process design.

Ferrite is in current use as a magnetic material. In terms of material design, the ferrite, having a high-permeability, realizes low efficiency in a quasi-microwave band since its specific permeability is reduced to a level of five or smaller in the GHz band due to Snoek's limit. Also, considering a magnetic relaxation factor among the ferrite's magnetization vectors, an electromagnetic wave absorber, manufactured using a ferrite, needs to have a thickness of at least 4 mm, which runs counter to the trend toward slimmer, lighter, and smaller products. Also, an Fe-based metal powder such as Fe—Si—Al (sendust) or Fe—Si has a high saturation magnetization value, but has a low permeability due to a high coercive force. Furthermore, a metal powder, such as Mo—Ni—Fe (MPP) or Ni—Fe (permalloy) mainly composed of Ni, has a high permeability but reacts weakly to external electromagnetic energy due to its low saturation magnetization value.

In order to increase the magnetic anisotropy of a soft magnetic metal powder and the packing factor of the magnetic powder in a polymer, a typical electromagnetic wave absorber mainly utilizes a soft magnetic powder that has been flaked. In general, a flaked soft magnetic powder is manufactured by processing a soft magnetic powder, having a flake size of a few to tens of microns, using long-duration high-energy ball milling. However, this long-duration high-energy ball milling impairs the efficiency of the powder flaking process, is inefficient due to the long-duration of the operation, and decreases the soft magnetic property due to the composition of a powder, the introduction of impurities, the nonuniformity in particle size, and an increase in the internal stress of particles. Thus, even in terms of process design, there has been no desirable process by which electromagnetic wave absorbers are manufactured.

The biggest disadvantage of the typical metal powder is a limitation in manufacturing a powder for the use in a wide band. In order to use electromagnetic wave absorbers in a wider range than an existing quasi-microwave band, the thickness of the soft magnetic metal powder needs to be reduced. However, in the case of using the typical high-energy ball milling, the efficiency is impaired as described above, and the manufacturing thereof is limited due to the introduction of impurities and the increase in internal stress.

Therefore, in the electronic products market, there is a need to conduct studies into a flake powder for electromagnetic wave absorbers, which can enhance a soft magnetic property by having a finer magnetic material structure with a high permeability and performing a low-energy flaking process, or can improve a dielectric property, which was low in existing metal powder, by controlling the interval or fine structure of the flake powder.

### SUMMARY OF THE INVENTION

An aspect of the present invention provides a flake powder for an electromagnetic wave absorber, which can be efficiently manufactured and has a high level of absorbency with respect to wide-band electromagnetic waves, and a method of manufacturing the same.

According to an aspect of the present invention, there is provided a flake powder for an electromagnetic wave absorber, including nano-sized metals and pores forming a flake body having a composite structure formed by the aggregation of nano-sized magnetic metals.

According to another aspect of the present invention, there is provided a method of manufacturing a flake powder for an electromagnetic wave absorber, the method including: preparing a metal oxide; milling the metal oxide into a nano-sized powder; reducing the milled metal oxide to form a magnetic metal powder; flaking the reduced magnetic metal powder; and performing a heat treatment on the flaked magnetic metal powder to relieve residual stress thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a conceptual view schematically illustrating the principle of reflecting electromagnetic waves;

FIG. 1B is a conceptual view schematically illustrating the principle of absorbing electromagnetic waves;

FIG. 2 is a conceptual view illustrating a structure design employing a sheet structure for an electromagnetic wave absorber and a composite structure of a nano powder;

FIG. 3 is a flowchart illustrating the process of manufacturing a flake nano metal powder for an electromagnetic wave absorber;

FIGS. 4A and 4B are images showing the fine structure of a composite oxide nano powder after bead milling;

FIG. 5 is a graph showing an X-ray diffraction pattern of the composite oxide nano powder;

FIGS. 6A and 6B are images showing the fine structure of a nano metal powder after hydrogen reduction;

FIG. 7 is a graph showing an X-ray diffraction pattern of the nano metal powder after hydrogen reduction;

FIGS. 8A through 8C are images showing the fine structure of a flaked nano metal powder;

FIG. 9 is a graph showing an X-ray diffraction pattern of the flaked nano metal powder;

FIGS. 10A through 10D are images showing the sectional fine structure of a composite sheet for an electromagnetic wave absorber, wherein FIG. 10A is associated with no heat treatment for residual stress relief, FIG. 10B is associated with a heat treatment at 600° C., FIG. 10C is associated with a heat treatment at 700° C., and FIG. 10D is associated with a heat treatment at 800° C.;

FIG. 11 is a graph showing the absorbency of an electromagnetic wave absorber sheet, formed using a flake nano metal powder, over a frequency variation;

FIG. 12 is an image showing the fine structure of a powder manufactured using an amorphous powder of an Fe—Si—B alloy; and

FIG. 13 is a graph showing the absorbency of a flake nano metal powder for an electromagnetic absorber over a frequency, according to a heat treatment for residual stress relief.

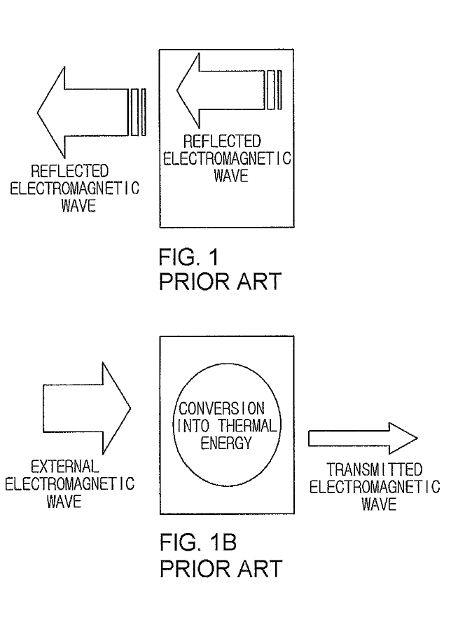

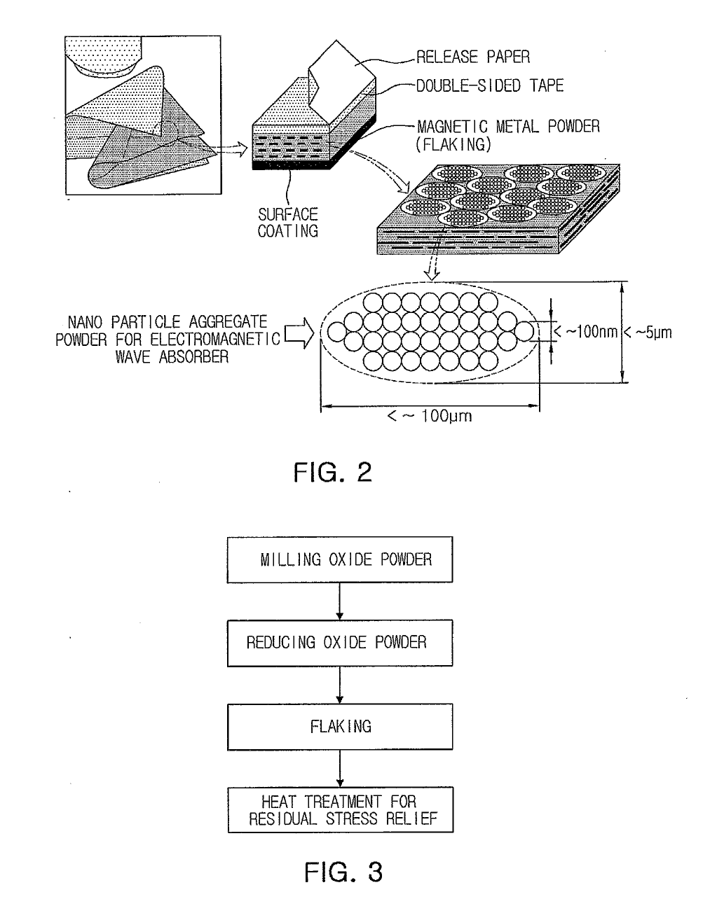

### DETAILED DESCRIPTION OF THE PREFERRED EMBODIMENT

Exemplary embodiments of the present invention will now be described in detail with reference to the accompanying drawings.

As a result of conducting studies to solve the disadvantages of electromagnetic wave absorbers manufactured by using a micron-scale flake magnetic powder according to the related art, the present inventors have found that a flake powder including nano-sized metals and pores, manufactured by producing a nano-sized magnetic metal powder using a metal oxide and performing a flaking process thereon, has an excellent absorbency of electromagnetic waves in a wide frequency range. On the basis of this finding, the present invention has been reached.

According to the present invention, a flake powder for an electromagnetic wave absorber is in the form of a flake body formed by the aggregation of nano-sized magnetic metal powders. According to the present invention, a nano metal powder is flaked so that a composite structure of nano-sized metals and nano-sized pores therebetween is formed by the aggregation of nano-sized metals.

A metal flake powder, according to the related art, has a dielectric property manifested only by an interval between flake powders. In contrast, a flake powder according to the present invention has a double or triple structure since it has not only the composite structure of the nano-sized metals and pores but also a secondary composite structure formed by the milling and aggregation of nano-sized metals during a flaking process. Accordingly, the dielectric property of the flake powder according to the present invention more than doubles that of the related art. This improves the permeability, the coercive force and the dielectric property of a nano-sized magnetic powder, thereby enhancing the electromagnetic-wave absorbency thereof, even in a wide band frequency region.

The nano metal powder is not limited, provided that it is a magnetic metal. The nano metal powder may be formed of one of a Fe-based metal, a Ni-based metal, a Co-based metal, and a Fe—Co-based metal and a Ni—Fe-based metal which are alloy phases of the above metals. In the present invention, the Fe—, Ni— and Co-based metals respectively cover all Fe—, Ni— and Co-based metals in an alloy phase. Preferably, the nano metal powder may be an Ni—Fe-based metal including 40 wt % to 90 wt % of Ni, or an Fe—Co based metal having 30 wt % to 70 wt % of Fe.

In order to attain sufficient electromagnetic wave absorbency, the nano-sized metal may have a size of 100 nm or less. Here, in the flake powder having the composite structure formed by nano-sized metals and pores, the pore size is 100 nm or less, and may preferably range between 1 nm to 10 nm. Depending on manufacturing conditions, in the case of forming the secondary composite structure, pores exist between metals of 100 nm or less, and range between 100 nm to 500 nm in size.

The flake powder, in the form of a flake body, has an average height of 1 μm or less and an average length of 20 μm. The flake powder needs to have the smallest possible height to maintain a magnetic property, and the longest possible length for a demagnetizing effect. However, if the flake powder has an indefinite length, the content of the powder cannot be increased when manufacturing an electromagnetic wave absorber. Therefore, the flake powder may have a length that is 20 times greater than the height thereof. Further, the electromagnetic wave absorbency has a frequency characteristic varied according to the height of the powder particles. Accordingly, the powder may be varied in height within the height range thereof so as to enhance the electromagnetic wave absorbency in a wide band.

Hereinafter, a method of manufacturing a flake powder for an electromagnetic wave absorber, according to the present invention, will be described in detail.

First, a metal oxide is prepared. The metal oxide employed for the present invention is not limited, but may preferably utilize one or two of a Ni-based oxide, a Fe-based oxide and a Co-based oxide.

The metal oxide is milled into a nano-sized powder. That is, a nano-sized powder having nano-sized metal oxide particles and pores is formed through the milling process. The milling may be performed using ball milling, bead milling, ultrasonic milling or an attritor, but is not limited thereto. Furthermore, in order to mill the metal oxide into uniform size, butanol, which is a dispersing agent, may be used. In this case, any dispersing agent, typically used for oxides, may be used.

The metal oxide, after the milling process, may have a size of 100 nm or less. In the event that two kinds of oxides are milled at the same time, they need to be uniformly mixed so as to be advantageous to alloying.

The nano-sized metal oxide, after the milling process, is reduced to a magnetic metal powder. The reduction process may be carried out in various reductive atmospheres, and may be, representatively, a hydrogen reduction or a nitrogen reduction.

The reduced nano-sized magnetic metal powder is flaked. The flaking process may be performed using ball milling, bead milling, ultrasonic milling or an attritor, but is not limited thereto. According to the present invention, the flaking process may be performed desirably using ball milling or ultrasonic milling which is a relatively low energy process. This is because the structure of the reduced powder is easily flaked, even with low energy. However, according to the related art, using ball milling or ultrasonic milling fails to achieve more than 20% of an electromagnetic wave absorption ratio in a quasi-microwave band. Furthermore, according to the present invention, the reduced powder, when flaked using high-energy milling, maybe manufactured within a shorter duration of time as it is in the related art.

By the flaking process, a flake powder having a composite structure formed by the aggregation of nano-sized metals and pores, is manufactured. The flaking process forms the flake powder having the composite structure of nano-sized metals and pores through milling and aggregation, and a flake powder having a secondary composite structure depending on manufacturing conditions.

In order to relieve the residual stress of the flaked nano-sized metal powder, a heat treatment is performed. In general, the milling process for flaking causes compressive residual stress to exist within the aggregated composite structure. Since the residual stress adversely affects magnetic spin order, the residual stress needs to be relieved in order to achieve a low coercive force. The residual stress may be relieved by applying energy from the outside through a heat treatment. The heat treatment maybe varied according to the kind and amount of metal powder, and may be performed within a temperature range of 200° C. to 1400° C. Preferably, the flaked nano-sized metal powder may be thermally treated within a temperature range of 500° C. to 1000° C., and then cooled to room temperature at a cooling rate of 20° C./min or higher.

A heat-treatment temperature of less than 200° C. is not enough to generate sufficient energy to relieve stress. To supplement this insufficiency, the heat treatment needs to be carried out for a long time. However, this results in high economic loss as well as oxidation caused by long-time exposure, thereby increasing the possibility of impairing the properties thereof. In this regard, the heat treatment may be carried out at a temperature of 500° C. or higher so that defects such as economic loss or oxidation are minimized. The heat-treatment temperature exceeding 1400° C. causes particle growth as well as the relief of residual stress. Here, the particle growth deteriorates a magnetic property manifested in a nano-crystalline structure. In this regard, the heat treatment is carried out at a temperature of 1000° C. or less to thereby relieve residual stress and minimize the deterioration of the magnetic property caused by the particle growth.

Hereinafter, the present invention will be described in more detail by way of inventive examples.

### Inventive Example 1

1. Production of Nano-Sized Metal Powder

In this inventive example, a nano metal powder of Ni-20wt % Fe was prepared in order to use a nano-sized Ni—Fe metal powder.

To produce the Ni—Fe nano metal powder, Fe₂O₃ (Kojundo, 99.9%) having an average particle size of 1 mm and a density of 5.25 g/cm³, and an NiO powder having an average particle size of 7 mm and a density of 7.45 g/cm³ were prepared as starting materials.

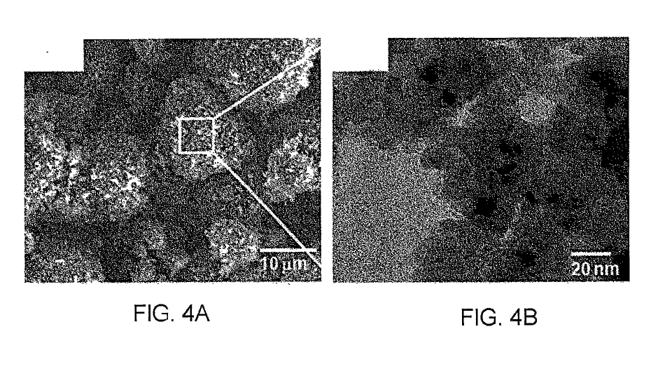

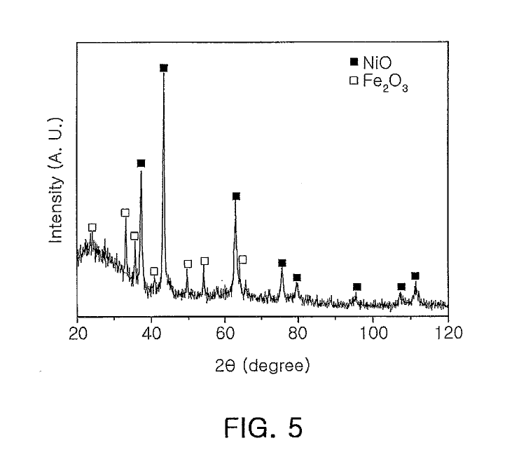

The prepared material was weighed to achieve the final composition of the nano metal powder, that is, Ni-20wt % Fe, and was subsequently mixed and milled using a horizontal cycle bead milling device or an attritor. To prevent oxide particles from clotting in this milling process, methyl alcohol (CH₃OH) was used as a process control agent (PCA) In the case of the horizontal cycle bead milling process, a disc rotation speed was controlled to 2400 rpm, and a powder-methyl alcohol liquid mixture in a mixing tank was controlled to be rotated at a speed of 180 rpm, and a pump circulated the liquid mixture at a speed of 50 rpm. The material of a milling vessel and a milling ball was ZrO₂. The milling was conducted within ten hours with the milling vessel packed at 80 volume percent. FIGS. 4A and 4B illustrate the fine structure of a composite oxide nano particle obtained by the bead milling, and FIG. 5 illustrates an X-ray diffraction pattern thereof.

Referring to FIG. 4A, it can be seen that an oxide powder after the milling process has aggregated composite structures having an average size of 20 μm to 30 μm. Also, it can be seen from FIG. 4B that the aggregated composite structures include fine oxide particles having an average size of 20 nm and nano-sized pores therebetween. Also, referring to FIG. 5, peaks are not observed except for NiO and Fe₂O₃, and this implies that the introduction of impurities during the horizontal milling process is negligible.

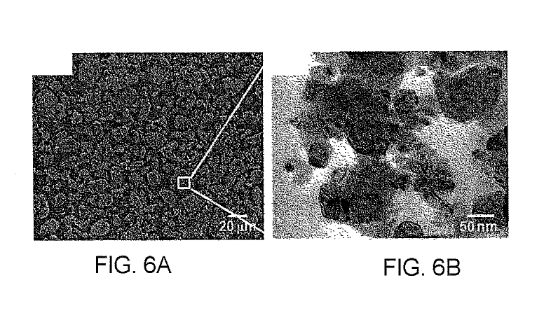

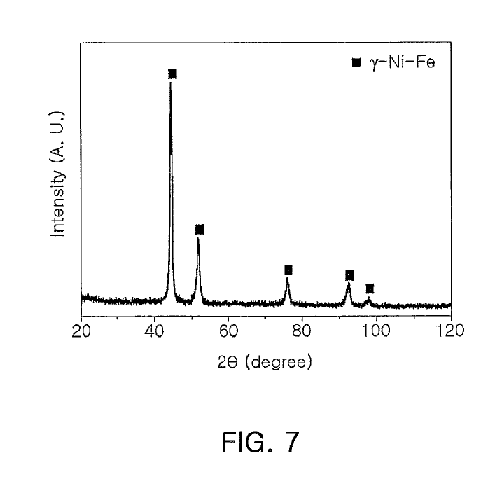

The milled oxide was dried sufficiently in a drying furnace at a temperature of 80° C., and was then reduced in an hydrogen atmosphere at 600° C. for an hour, thereby manufacturing an Ni—Fe nano metal powder. This reduction atmosphere contained a hydrogen gas (99.999%) having a dew point of −77° C., and a gas flow rate was maintained at 4.5 l/min. The reduced nano metal powder was cooled to room temperature in a cooling chamber in an argon atmosphere (99.9%), connected to a reduction furnace, at a cooling rate of about 50° C./min, and was then transferred to a glove box in an argon atmosphere to thereby continue the powder manufacturing process in a non-oxidizing atmosphere. Notably, the oxygen and moisture contents within the glove box were maintained at 200 ppm or less in order to prevent the reoxidation and surface contamination of the Ni—Fe nano metal powder. FIGS. 6A and 6B respectively illustrate a scanning electron microscopic SEM image and a transmission electron microscopic (TEM) image of the nano metal powder of reduced Ni-20wt % Fe, and FIG. 7 illustrates an X-ray diffraction pattern thereof.

Referring to FIG. 6A, it can be seen that the nano metal powder of Ni-20wt % Fe forms an aggregated composite structure of about 20 μm. Also, referring to FIG. 6B, it can be seen that this aggregated composite structure includes polycrystalline particles of about 80 nm, and pores of similar size to the particle size. In addition, no peak of impurities is observed in FIG. 7, and the nano metal powder is in a gamma Ni—Fe single phase alloy.

2. Flaking Process

The nano metal powder was subjected to a milling process for flaking by using an attritor. The nano metal powder of 100 g was subjected to the milling process for flaking at a rotation speed of 300 rpm for five hours by using the attritor. Here, the weight ratio of balls to powder was 70:1. The vessel volume of the attritor used in the milling process for flaking was 2000 ml, and the material of the attritor was stainless steel. The steel material was used in order to minimize contamination during this ball milling process for flaking. The nano metal powder after the flaking process was dried through filtering using a vacuum pump. The dried reduced powder is in the form of a cracked cake, and is sieved with 100 meshes to attain a uniform powder.

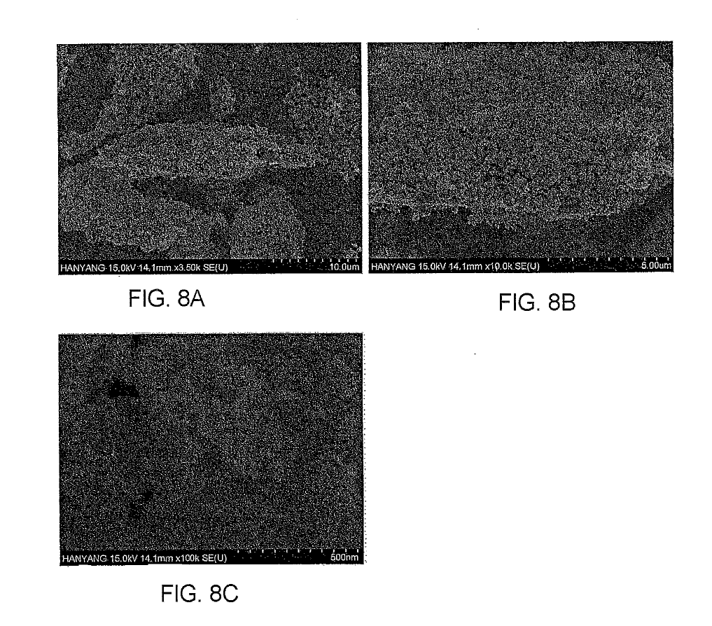

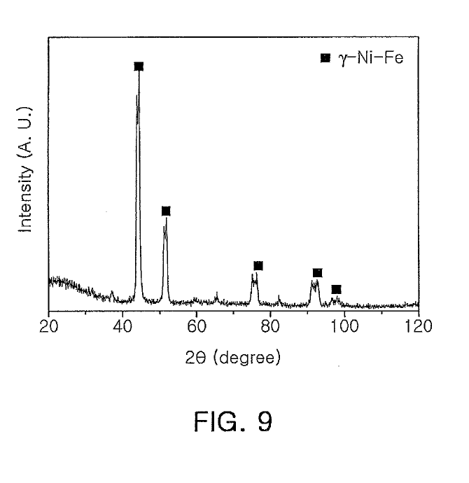

FIGS. 8A through 8C are images of the fine structure of the flake nano metal powder of Ni-20wt % Fe. The flake nano metal powder has a flake-shaped aggregated composite structure having an average height of 1 μM and an average length of 20 μm. Notably, FIG. 8C illustrates the inside of the aggregated composite structure, and it can be seen from FIG. 8C that the composite structure has spherical nano particles of an average size of 80 nm and pores of a similar size thereto. FIG. 9 is a graph showing the X-ray diffraction analysis of the flake nano metal powder of Ni-20wt % Fe. Referring to FIG. 9, it can be seen that the flaked nano metal powder is in a Ni—Fe gamma phase.

3. Heat Treatment for Residual Stress Relief

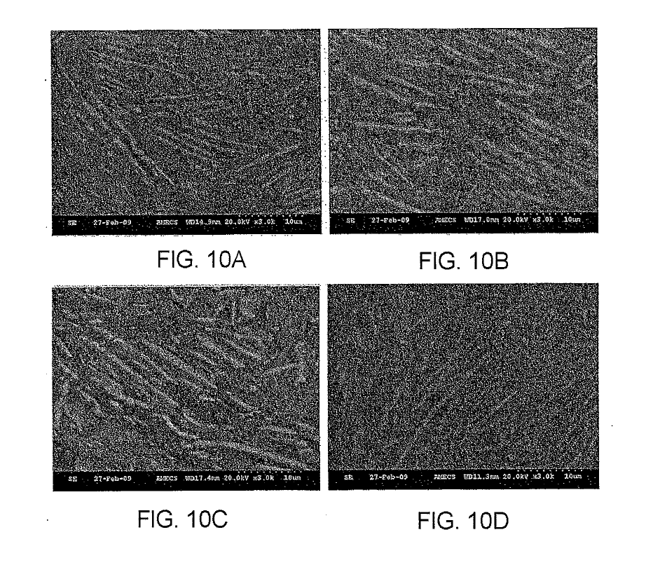

In order to relieve the residual stress of the flake nano metal powder, the flake nano metal powder was subjected to a heat treatment within a temperature range of 600° C. to 900° C. in a hydrogen atmosphere, and was then cooled to room temperature in a cooling chamber at a cooling rate of 20° C./min. FIGS. 10A through 10D are images of the sectional fine structure of a composite sheet for an electromagnetic wave absorber, respectively illustrating the cases where the heat treatment for residual stress relief is not conducted, where the heat treatment is conducted at 600° C., where the heat treatment is conducted at 700° C., and where the heat treatment is conducted at 800° C. As shown above, the heat treatment for residual stress relief is contributive to achieving mostly uniform shapes and sizes of aggregated composite structures.

4. Measurement of Magnetic Property

The magnetic property of the reduced powder and the flake powder was measured by applying a magnetic field to a sample in a direction parallel to the surface of the sample with an electromagnetic having a maximum magnetic field intensity of 20 KG by using a vibrating sample magnetometer (VSM). The magnetometer was corrected using high-purity Ni before measuring the magnetic property of the sample. The external magnetic field was measured at room temperature while being reduced from 10 KG to −10 KG and then varied up to 10 KG for an hour. Using a magnetization curve obtained in this manner, the saturation magnetization and the coercive force were measured.

5. Measurement of Electromagnetic Wave Absorption Ratio

A sample for measuring an electromagnetic wave absorption ratio was produced as a 5 cm×5 cm sheet using a doctor blade technique. Here, the sheet was produced to have a thickness of 0.2 mm. The sheet was produced by mixing a powder with TP273/E50 C-MIX2000, added as a binder, at a weight ratio of 1:1, adding thereto a small amount of BC thinner for flow-rate control, and then making the resultant material into a sheet form using rolling equipment. As for a measuring frequency range, the electromagnetic wave absorption rate (i.e., power loss) was measured within a frequency range of 1 MHz to 13.5 GHz, and the permeability and the permittivity (i.e., dielectric constant) were measured at a frequency range of 1 MHz to 10 GHz.

For the comparison of electromagnetic wave absorbency, a comparative sample was produced as follows.

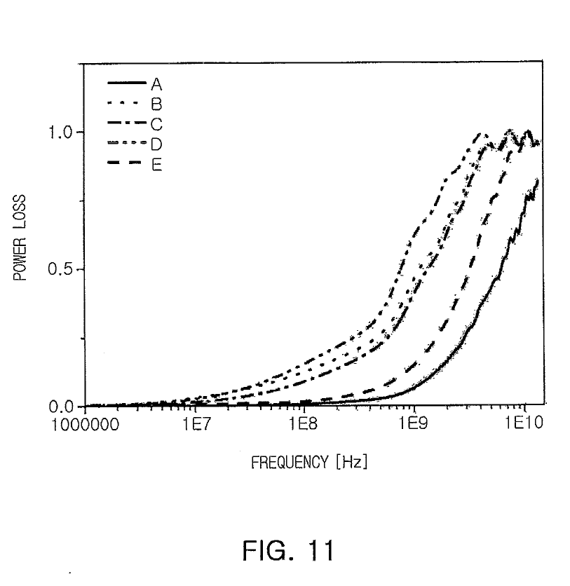

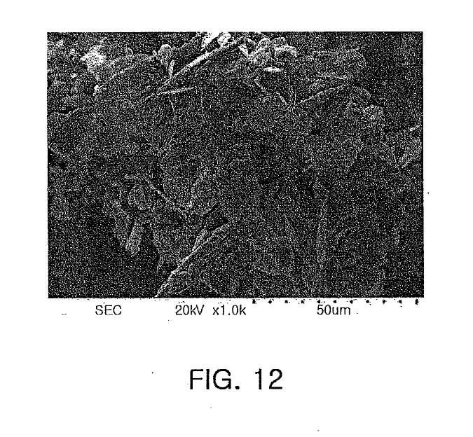

The comparative sample was produced under the same conditions as above, and an amorphous powder of Fe—Si—B alloy, manufactured by AMO Corporation was used as a powder. The average size of the powder was 20 μm, and the thickness thereof was about 1 μm. FIG. 12 is an image of the fine structure of the powder produced by AMO Corporation. The Fe—Si—B powder was subjected to ball milling at 700 rpm for 20 hours by using an attrition mill. This ball milling process was carried out until this comparative powder was flaked at the same flaking ratio as that of the flake powder produced according to the present invention. In this case, the ball-milling speed was 2.5 times higher than that of the present invention, and the ball milling duration was four times longer than that of the present invention. In order to relieve stress to the same extent as in the present invention, the heat treatment was conducted at 420° C., and the result thereof is shown in FIG. 11.

FIG. 11 illustrates the result of an electromagnetic wave absorption ratio (Pₗₒₛₛ/Pᵢₙ). Referring to FIG. 11, it can be seen that the electromagnetic wave absorption ratio is low when no heat treatment for residual stress relief is carried out (see curve A in FIG. 11). However, when the heat treatment for residual stress relief is conducted (see curves B, C and D in FIG. 11), an absorption ratio is the maximum of 61% in a frequency range between 1 GHz and 2 GHz. This result, at 1 GHz, is about 3.6 times improvement in performance as compared to the comparative sample (see curve E in FIG. 11) manufactured using the Fe—Si—B powder and having the maximum absorption ratio of 17%.

### Inventive Example 2

Table 1 below shows comparison results between electromagnetic wave absorbers manufactured by the inventive example 1 and currently used electromagnetic wave absorbers. Currently used products are the most superior products from Korean company A and Japanese company B, and a frequency band for this comparison is 1 GHz. In Table 1 below, inventive materials 1 through 3 are the same as those in the above inventive example 1, and the same measuring method as in the inventive example 1 was applied thereto. As shown in Table 1 and FIG. 11, a comparative material has a low absorption ratio since no heat treatment for residual stress relief is performed. However, in the case of the inventive materials utilizing the nano metal flake powder according to the present invention, the absorption ratios thereof are higher than the comparative material by 26% to 39%.

TABLE 1

| | | | | | Ab- |
|---|---|---|---|---|---|
| | | | | Heat treatment | sorp- |
| | | | Thick- | for residual | tion |
| | | Content | ness | stress relief | ratio |
| Comparative | Nano | Ni—Fe | 0.2 mm | None | 6.3% |
| material | metal | | | | |
| (FIG. 11, A) | flake | | | | |
| Inventive | powder | | | 600° C. | 40% |
| material | | | | | |
| 1(FIG. 11, B) | | | | | |
| Inventive | | | | 700° C. | 47% |
| material | | | | | |
| 2(FIG. 11, C) | | | | | |
| Inventive | | | | 800° C. | 61% |
| material | | | | | |
| 3(FIG. 11, D) | | | | | |
| Current-use | Micro | Fe—Si—Al | | 700° C. | 17% |
| material | flake | | | | |
| Current-use | powder | | | 700° C. | 35% |
| material | | | | | |

### Inventive Example 3

In order to measure the electromagnetic wave absorption ratio of electromagnetic wave absorbers over the temperature of the heat treatment for residual stress relief, samples for electromagnetic wave absorbers having sheet thicknesses, densities and relative densities shown in Table 2 below were produced using the nano metal powder having undergone the milling process for flaking according to the inventive example 1. Thereafter, the samples were subjected to the heat treatment for residual stress relief at different temperatures as shown in Table 2 below.

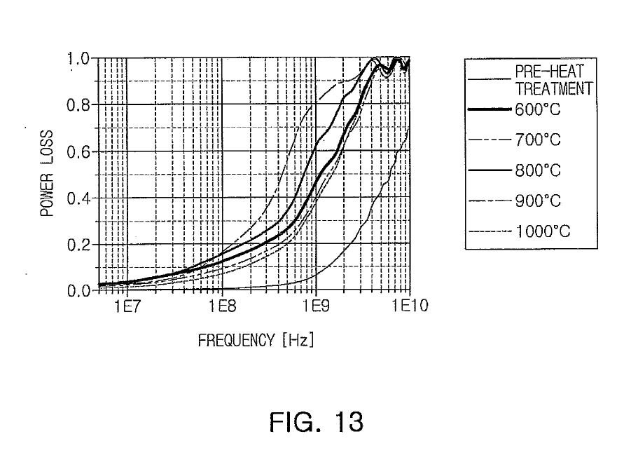

The electromagnetic wave absorption ratio of each sample after the heat treatment for residual stress relief was measured by the measuring method of the inventive example 1. The result thereof is shown in Table 3 and FIG. 13.

TABLE 2

| | | Heat treatment temperature | | | | |
|---|---|---|---|---|---|---|
| Powder | Pre-heat | 600° | 700° | 800° | 900° | 1000° |
| condition | treatment | C. | C. | C. | C. | C. |
| Sheet | 0.18 | 0.19 | 0.19 | 0.18 | 0.19 | 0.19 |
| thickness(mm) | | | | | | |
| Density(g/cm³) | 3.3 | 3.67 | 3.75 | 3.63 | 3.57 | 3.76 |
| Relative | 38.4 | 42.7 | 43.0 | 41.6 | 40.5 | 43.2 |
| density(% T.D.) | | | | | | |

TABLE 3

| | | | Heat treatment temperature | | | | |
|---|---|---|---|---|---|---|---|
| | | Pre-heat | 600° | 700° | 800° | 900° | 1000° |
| Frequency | | treatment | C. | C. | C. | C. | C. |
| 10 | MHz | 0.09% | 3.04% | 1.52% | 2.69% | 2.15% | 1.35% |
| 100 | MHz | 0.6% | 12.45% | 8.88% | 15.43% | 16.56% | 7.35% |
| 1 | GHz | 6.4% | 45.96% | 40.59% | 61.39% | 80.38% | 37.87% |

As shown in Table 3 and FIG. 13, the sample, when subjected to no heat treatment for residual stress relief, has a low absorption ratio at 1 GHz. In contrast, even when the heat treatment temperature is 1000° C., a high electromagnetic absorption ratio of 37.87% is attained. However, in this case, the absorption ratio is relatively lower than when the heat treatment temperature is lower than 1000° C. On the basis of the results thereof, it can be seen that the coercive force increased by a flaking process is reduced due to the heat treatment for residual stress relief. Furthermore, the heat treatment temperature exceeding 1000° C. results in both the decrease in coercive force and particle growth, and this impairs the magnetic property attainable in a nanostructure, thereby lowering the electromagnetic wave absorption ratio.

As set forth above, according to exemplary embodiments of the invention, a nano metal powder can be manufactured in a flake phase even with low energy in a flaking process, thereby increasing the yield of usable powder. Furthermore, and an electromagnetic wave absorber usable in a wide band frequency can be produced since a smaller powder thickness than that of an existing powder can be achieved, and there exist two and three boundaries such as between initial particles and a flake powder having a composite structure, and between initial particles, a flake powder and a flake powder having a secondary composite structure formed depending on manufacturing conditions.

The flake powder having such multiple boundaries improves an electromagnetic wave absorption ratio by having a magnetic property even when the soft magnetic property thereof is lowered.

While the present invention has been shown and described in connection with the exemplary embodiments, it will be apparent to those skilled in the art that modifications and variations can be made without departing from the spirit and scope of the invention as defined by the appended claims.

What is claimed is:

1. A flake powder for an electromagnetic wave absorber, the flake powder comprising nano-sized metals and pores forming a flake body having a composite structure formed by aggregation of nano-sized magnetic metals.

2. The flake powder of claim 1, wherein the magnetic metals are Fe-based metals, Ni-based metals, Co-based metals, Ni—Fe-based metals, or Fe—Co-based metals.

3. The flake powder of claim 2, wherein the Ni—Fe-based metals include 40 wt % to 90 wt % of Ni and the balance of Fe, and the Fe—Co-based metals include 30 wt % to 70 wt % of Fe and the balance of Co.

4. The flake powder of claim 1, wherein the nano-sized metals and pores have a size of 100 nm or less.

5. The flake powder of claim 1, wherein the flake body has an average height of 1 μm or less and an average length of 20 μm or less.

6. A method of manufacturing a flake powder for an electromagnetic wave absorber, the method comprising:
preparing a metal oxide;
milling the metal oxide into a nano-sized powder;
reducing the milled metal oxide to form a magnetic metal powder;
flaking the reduced magnetic metal powder; and
performing a heat treatment on the flaked magnetic metal powder to relieve residual stress thereof.

7. The method of claim 6, wherein the metal oxide is one or two of a Ni-based oxide, an Fe-based oxide and a Co-based oxide.

8. The method of claim 6, wherein the milling of the metal oxide uses ball milling, ultrasonic milling, bead milling or an attritor.

9. The method of claim 6, wherein the reducing of the milled metal oxide is performed in a hydrogen or nitrogen atmosphere.

10. The method of claim 6, wherein the flaking of the reduced magnetic metal powder is performed using ball milling, ultrasonic milling, bead milling or an attritor.

11. The method of claim 6, wherein the heat treatment is performed within a temperature range between 200° C. and 1400° C.

12. The method of claim 11, wherein the heat treatment is performed within a temperature range between 500° C. and 1000° C.
